(19) United States
(12) Patent Application Publication
(10) Pub. No.: US 2023/0027484 A1
(43) Pub. Date: Jan. 26, 2023

(54) Plastic Films

(71) Applicants: DOW SILICONES CORPORATION, Wilmington, DE (US); MULTIBASE S.A., Saint Laurent du Pont (FR)

(72) Inventors: CELINE CHEVALLIER, Cran Gevrier (FR); JEAN DE LA CROIX HABIMANA, Maurage (BE); XAVIER MARTINEZ, Saint Pierre De Chartreus (FR); AUDREY MISCIOSCIA, Quincieu (FR); PATRICK PRELE, Cognin (FR)

(21) Appl. No.: 17/930,433

(22) Filed: Sep. 8, 2022

Related U.S. Application Data
(63) Continuation of application No. 16/305,631, filed on Nov. 29, 2018.

(30) Foreign Application Priority Data
Jun. 3, 2016 (EP) 16305654.2
Aug. 5, 2016 (EP) 16306026.2

(51) Int. Cl. B32B 27/08; B32B 27/28; B32B 27/32; C08G 77/20; C08J 3/00; C08L 23/26

(52) U.S. Cl. CPC B32B 27/08; B32B 27/283; B32B 27/32; C08G 77/20; C08J 3/005; C08L 23/26; B32B 2250/02; B32B 2250/03; B32B 2270/00; B32B 2323/04; B32B 2323/10; B32B 2383/00; C08L 2203/16; C08L 2310/00

(57) ABSTRACT

The invention relates to plastic films and a silicone containing polymer blend composition that can be used in the production of the plastic films which is a polymer composition obtainable from, per 100 parts by weight of the composition, 99.99 to 90 parts by weight of a polyolefin polymer (P) and 0.01 to 10 parts by weight of a masterbatch (M).

This application is a Continuation of U.S. patent application Ser. No. 16/305,631 filed Nov. 29, 2018, currently pending, which is the U.S. national stage filing under 35 U.S.C. § 371 of PCT Application No. PCT/IB17/000848 filed on Jun. 2, 2017, currently expired, and which claims the benefit of EP Patent Application No. 16305654.2 filed Jun. 3, 2016 and EP Patent Application No. 16306026.2 filed Aug. 5, 2016 under 35 U.S.C. § 119 (e). U.S. patent application Ser. No. 16/305,631, PCT Application No. PCT/IB17/000848, EP Patent Application No. 16305654.2, and EP Patent Application No. 16306026.2 are hereby incorporated by reference.

The invention relates to plastic films made using a silicone containing polymer blend composition and their methods of manufacture.

A plastic film may be formed as a monolayer or alternatively may have multiple layers. Usually, plastic films requiring a low coefficient of friction have at least 2 layers:

(i) an outer layer (or skin layer), and
(ii) a base resin layer.

For the packaging industry, the typical structure is a three layers film, with a core layer and two opposite outer layers. The first outer layer is intended to be printed, metallized or laminated, and the second outer layer is the layer where the friction reduction is needed. It is a common issue to lower the coefficient of friction in order for “form fill seal” (FFS) processes to increase the output. Some organic chemistry based solutions have been proposed i.e. using erucamide or oleamide layers to obtain excellent low friction properties. But they rapidly migrate through the different layers of the film construction, to finally evaporate from the film surface. Thus, they cannot maintain the good friction property for a long time.

In WO2015/132190, polydimethylsiloxane is reactively blended with a thermoplastic organic polymer so that a copolymer is formed in the masterbatch. It was found that the reaction between the thermoplastic and the polydimethylsiloxane enhanced the scratch properties of automotive compounds.

WO98/10724 describes a process of making a low peel force plastic layer that has good release properties, consisting of a polymer resin composition containing silicone compounds incorporated as additives within the plastic film layer and are extruded or co-extruded with said film, said silicones being bound within the film so as to prevent substantial migration. The silicone composition described therein contains (1) vinyl trimethoxysilane, (2) a hydroxy dimethylsilyl capped siloxane, (3) an ultra-high molecular weight siloxane, optionally (4) an organo-peroxide agent and (5) an organo-metallic moisture curing agent.

### SUMMARY OF THE INVENTION

There is provided herein a plastic film comprising one or more layers obtainable by:—
(I) forming a masterbatch (M) by reactively mixing under shear an organopolysiloxane (B) containing on average at least 1 alkenyl functionality per molecule with a polyolefin polymer (A), at a temperature such that the organopolysiloxane (B) and the polyolefin polymer (A) are in liquid phase, so as to form a copolymer of (A) and (B) then cooling the formed copolymer to produce said masterbatch (M) in solid form containing organopolysiloxane (B), polyolefin polymer (A) and the copolymer of (A) and (B); then
   (ii) Introducing, per 100 parts by weight, 0.01 to 10 parts by weight of masterbatch (M) into 99.99 to 90 parts by weight of a polyolefin polymer (P) and blending to form a composition and
(iii) making a film by processing the composition of step (ii).

The film as defined above can be a complete film or one layer of film comprising multiple layers.

We have found that a more advanced friction system is obtained by reactively mixing a vinyl containing siloxane with a polyolefin such as polyethylene, polypropylene or a copolymer thereof without adding any catalyst such as a free radical generator. Antioxidants may be added to the composition to control the reaction. Organopolysiloxane (B) at least partially reacts with polyolefin polymer (A) to make a siloxane/polyolefin copolymer. The resulting product of the reaction comprises unreacted organopolysiloxane (B), unreacted polyolefin polymer (A) and the copolymer of (A) and (B). The resulting product may be added to the polyolefin (P) at low level to reduce the friction of the plastic film. The resulting product can be used as a low peeling force additive. The resulting product, i.e. a blend of unreacted organopolysiloxane (B), unreacted polyolefin polymer (A) and the copolymer may be produced in pellet form ready to be premixed into the resin during film production. When producing a multilayer film construction, the additive is added in the outer layer which needs typically such property.

We have discovered that using the resulting product of unreacted organopolysiloxane (B), unreacted polyolefin polymer (A) and the copolymer as an additive in polyolefin polymer (P) results in a film having a decreased coefficient of friction compared to films made in the same manner containing a mixture of unreacted (A) and (B).

Whilst it is believed that the greater the completion of the copolymerisation reaction between organopolysiloxane (B) and polyolefin polymer (A), the lower the coefficient of friction, the copolymerization does not go to completion and as such unreacted organopolysiloxane (B), unreacted polyolefin polymer (A) are present in the resulting product.

A polymer is a compound containing repeating units which units typically form at least one polymeric chain. A polymer can be a homopolymer or a copolymer. A homopolymer is a polymer which is formed from only one type of monomer. A copolymer is a polymer formed from at least two different monomers. A polymer is called an organic polymer when the repeating units contain carbon atoms. A resin is typically a polymer or a composition based on one or more polymers.

Some polymers are thermoset: once cooled and hardened, these polymers retain their shapes and cannot return to their original form. Other polymers are thermoplastics: they can soften upon heating and return to their original form. Plastic films are films with plastic properties obtained from a composition or plastic materials comprising at least one polymer, usually thermoplastic polymer for example a polyolefin polymer.

Polyolefin polymer (P) may include any suitable polyolefin such as for example polyethylene such as low density polyethylene (LDPE), linear low density polyethylene (LLDPE) and high density polyethylene (HDPE), polypropylene (PP) polymethylpentene, polybutene-1 (PB-1) or a blend/mixture thereof. Typically polyolefin polymer (P) comprises polypropylene and/or polyethylene.

Polyolefin polymer (P) may be functionalized, preferably with an alkyl acrylate function such as methyl acrylate, ethyl acrylate, butyl acrylate, or an acrylic function or maleic anhydride function.

A polysiloxane contains several Si—O—Si— bonds forming a polymeric chain, where the repeating unit is —(Si—O)—. An organopolysiloxane is sometimes called a silicone. An organopolysiloxane contains repeating —(Si—O)— units where at least one Si atom bears at least one organic group. “Organic” means containing at least one carbon atom. An organic group is a chemical group comprising at least one carbon atom.

A polysiloxane comprises terminal groups and pendant groups. A terminal group is a chemical group located on a Si atom which is at an end of the polymer chain. A pendant group is a group located on a Si atom which Si atom is not at the end of the polymeric chain.

A gum is a usually made of a polymer of high molecular weight. A gum takes the form of a fluid having a high viscosity. A gum has typically a viscosity of at least 1000000 mPa·s at 25° C. A gum can have a viscosity of up to 2000 000 mPas at 25° C. or even more, e.g. 20,000,000 mPa·s at 25° C. or greater.

A masterbatch is a concentrated mixture of pigments and/or additives in a solid or liquid for introduction into plastic materials. Masterbatch (M) may be in any suitable form e.g. a solid or liquid, however it is preferably used with/introduced into e.g. polyolefin polymer (P) in a powder or pelletized form.

As hereinbefore described masterbatch (M) contains Organopolysiloxane (B) and Polyolefin polymer (A) as well as a copolymer of (A) and (B).

Organopolysiloxane (B) is a linear or branched polydialkylsiloxane having at least one alkenyl group per molecule. Typically Organopolysiloxane (B) is a linear polymer. Preferably each alkyl group may be the same or different and contains 1 to 10 carbon atoms. Hence the alkyl group may be a methyl group, an ethyl group, a butyl group, for example a tertiary butyl group. Preferably each alkyl group is a methyl group.

Organopolysiloxane (B) may have a number average molecular weight of 200,000 to 2.000,000 g/mol. Organopolysiloxane (B) may be a gum as defined above.

The alkenyl functionalities on organopolysiloxane (B) are pendant and/or terminal functionalities. Each alkenyl group may be the same or different and preferably has 2 to 7 carbon atoms. Preferably alkenyl (generally vinyl) functionalities are present in an amount comprised between 0.01% and 2.00% by weight of the organopolysiloxane (B). Preferably, the alkenyl functionalities of the organopolysiloxane (B) comprise vinyl functionalities.

Polyolefin polymer (A) may also include any suitable polyolefin such as for example polyethylene such as low density polyethylene (LDPE), linear low density polyethylene (LLDPE) and high density polyethylene (HDPE), polypropylene (PP) polymethylpentene, polybutene-1 (PB-1) or a blend/mixture thereof. Typically polyolefin polymer (A) comprises polypropylene and/or polyethylene.

Polyolefin Polymer (A) may also be functionalized, preferably with an alkyl acrylate function such as methyl acrylate, ethyl acrylate, butyl acrylate, or an acrylic function or maleic anhydride function.

Polyolefins (A) and (P) may be the same or different in that they may identical forms of the same polyolefin e.g. polyethylene or different forms of the same polyolefin and indeed completely different olefins. When polyolefins (A) and (P) are of the same nature they may show higher compatibility.

In a further embodiment there is provided a masterbatch (M) for use as an additive in a polyolefin polymer (P) composition used to form a film, wherein the masterbatch (M) is obtained by reactively mixing under shear an organopolysiloxane (B) containing on average at least 1 alkenyl functionality per molecule with a polyolefin polymer (A), at a temperature such that the organopolysiloxane (B) and the polyolefin polymer (A) are in liquid phase, so as to form a copolymer of (A) and (B) then cooling the formed copolymer to produce the masterbatch in solid form containing organopolysiloxane (B), polyolefin polymer (A) and the copolymer of (A) and (B). Masterbatch (M) may contain between 1 and 99% by weight of copolymer of (A) and (B), between 0.5 and 74.5% by weight of polyolefin polymer (A) and between 0.5 and 49.5% by weight of organopolysiloxane (B) with the wt. % combination of (A)+(B)+(copolymer of (A) and (B)) being=100 wt. %.

Masterbatch (M) may be used as a non migrating slip additive in a polyolefin polymer (P) to improve (i.e. to decrease the value of) the coefficient of friction of a film comprising the polyolefin polymer (P).

In a still further embodiment there is provided a method of making a plastic film comprising one or more layers by:—
(i) forming a masterbatch (M) by reactively mixing under shear an organopolysiloxane (B) containing on average at least 1 alkenyl functionality per molecule with a polyolefin polymer (A), at a temperature such that the organopolysiloxane (B) and the polyolefin polymer (A) are in liquid phase, so as to form a copolymer of (A) and (B) then cooling the formed copolymer to produce said masterbatch (M) in solid form containing organopolysiloxane (B), polyolefin polymer (A) and the copolymer of (A) and (B); then
   (ii) Introducing, per 100 parts by weight, 0.01 to 10 parts by weight of masterbatch (M) into 99.99 to 90 parts by weight of a polyolefin polymer (P) and blending to form a composition and
(iv) making a film by processing the composition of step (ii).

The resulting masterbatch (M) of step (i) may be a powder or may be in the form of pellets.

The polymer composition (i.e. blend of polyolefin polymer (P) and masterbatch (M) resulting from step (ii)) as hereinbefore described may also contain one or more suitable additives, for example antistatic additives, anti-blocking additives and/or anti-fogging additives.

Any suitable technique for making a film from the polymer composition resulting from step (ii) may be utilized in step (iii) of the process to construct a film. Step (iii) may involve, for example, cast co-extrusion or blown co-extrusion methods, adhesive lamination, extrusion lamination, thermal lamination, melt pressing and coating methods such as vapor deposition. Combinations of these methods are also possible. Suitable films may also be e.g. stretched after extrusion

Hence, Step (iii) may, for example, involve a process for making, for example, but not restricted to biaxially orientated polypropylene (BOPP) films, casted films, double bubble and blown films e.g. blown polyethylene films.

Films made from the polymer composition of step (ii) as hereinbefore described may be used in any suitable application, for example it may be used in or as a layer in the packaging industry. The typical structure of such films have multiple layers, often for this application three layers, a core layer and two opposite outer layers. The first outer layer is intended to be printed, metallized or laminated, and the second outer layer is the layer where the friction reduction is needed. The polymer composition resulting from step (ii) as hereinbefore described may be utilized as or in said second outer layer.

The filmic manufacturer will determine the number and order of the filmic layers required for their filmic products. The filmic products will determine the method of making the required films dependent on the end use. In the case of extruded films, these may typically be made by use of one extruder for each layer of film. Compositions for use as each layer in the film will be added to individual extruders respectively and will then undergo appropriate extrusion regimes in their respective extruders with the resulting extruded layers of film are brought together and amalgamated as appropriate to generate the end filmic product.

The polymer composition generated in step (ii) of the process as hereinbefore described may be used to make at least one external layer of a film in step (iii). The masterbatch can for example be added as 2 to 5 parts by weight per 100 parts by weight of the composition of the external (skin) layer of a multilayer film.

The plastic films containing one or more layers of film made in step (iii) from the polymer composition of step (ii) as hereinbefore described may be packaging multilayer plastic films. Low coefficient of friction is always a need for plastic film processing and for Form, Fill &Seal (FFS) processes for food packaging, e.g. pet food bags, meat packaging, snack wrapping, or the like. The masterbatch can be added in the components forming the low SIT (seal initiation temperature) skin layer used for example for food packaging films. The masterbatches as hereinbefore described provide one or more of the following advantages to the films made in step (iii) herein:
improved extrusion/compounding process: processing aid helping to maximize manufacturing productivity
no migration of the masterbatch components in the other layers of the film (non-migrating additive)
a reduction in coefficient of friction for films (slip additive)
no change of SIT
no transfer effect (stable coefficient of friction)
cost effectiveness
maintain surface tension values
stability against thermal ageing
no or very low effect on haze for transparent films
compatibility with corona post-treatment
enabling printability, lamination or metallization of the film.

We are now going to illustrate the invention with the following examples. It is to be noted that the term “initial silicone content” employed in the tables refers to the silicone content introduced during the masterbatch fabrication, before the chemical reaction with the resin. Film on Film coefficient of friction results were determined using measured in accordance with ASTM 1894-14 using a Zwick tensile machine. Film on steel coefficient of Friction test were undertaken using an Oscillating Tribotester as disclosed below.

### POLYETHYLENE (PE) EXAMPLE

### Example 1: Preparation of the Silicone Masterbatch of Different Viscosities and Molecular Weights

Pellets of low density polyethylene (Polyolefin polymer (A)) with a melt flow index (MFI) of 8.5 g per 10 min (using the testing conditions of a temperature of 190° C. and load of 2.16 kg) as the polymer matrix of masterbatch (M), are introduced into a co-rotative Twin screw extruder sometimes with stabilizer (see Table 1 below) (typically Irganox® 1010 antioxidant) in an amount as indicated in Table 1 below 0.5 wt. %. Then organopolysiloxane (B) is added into the already melted polyethylene phase using a gear pump. The average amount of organopolysiloxane (B) introduced into the matrix polyethylene is about 50 wt. %.

All the components are mixed in a lab twin screw extruder having a length/diameter (L/D) ratio of greater than 40 (typically 48), diameter of the screw greater than 35 mm (typically 40 mm), then average screw speed is set to 550 rpm with a specific screw profile designed to disperse finely all the components into the polyethylene. The mixtures are coiled with a water batch to room temperature and pelletized. The pellets are analysed with a rheometer with a frequency sweep test at 190° C., and deformation (Y)=2% to determine the viscosities. In Table 1 the values of complex loss modulus (G*) at 0.1 Hz are provided. Pellets of masterbatch (M) also undergo an extraction test as follows: around 0.24 g of masterbatch was accurately weighed and placed into a 20 ml headspace vial. 10 ml of p-xylene were accurately added (micropipette) and the vial was crimped. The samples were left to solubilize at high temperature (150° C.) for 20 minutes under continuous agitation using the headspace oven and the autosampler of a GC-MS (MPS from Gerstel). After cooling 10 ml of toluene were added and the samples were left under gentle stirring for 24 h (using a rotary shaker). The samples were then filtered through 0.45 μm PTFE filters into 2 ml glass auto sampler vials.

All data is compiled in Table 1.

TABLE 1
Table 1: Process conditions, extraction in xylene
and complex modulus data for each run carried out
using vinyl endcapped and pendent (0.725% of vinyl
function) high molecular weight silicone polymer.

| | | | Phenolic | Silicone | |
|---|---|---|---|---|---|
| | | | Antioxidant | extraction | G* at |
| | Temperature | Output | at 0.3% | in xylene | 0.1 Hz |
| | (° C.) | (kg/h) | (Y/N) | (%) | (Pa) |
| 1 | 250 | 100 | N | 7.1 | 10332 |
| 2 | 250 | 100 | Y | 25.6 | 5294 |
| 3 | 250 | 40 | N | 4.2 | 11453 |
| 4 | 250 | 40 | Y | 19.2 | 4284 |
| 5 | 190 | 60 | N | 11.3 | 8245 |
| 6 | 190 | 60 | Y | 44.2 | 1506 |
| 7 | 140 | 100 | N | 34.8 | 2989 |
| 8 | 140 | 100 | Y | 44.2 | 1564 |
| 9 | 140 | 40 | N | 22.5 | 6182 |
| 10 | 140 | 40 | Y | 44.8 | 1445 |
| 11 | 190 | 40 | N | 13.9 | 11818 |
| 12 | 190 | 100 | N | 18.1 | 9512 |
| 13 | 210 | 40 | N | 10.1 | 12374 |
| 14 | 210 | 100 | N | 11.5 | 11490 |
| 15 | 230 | 40 | N | 8.5 | 12709 |
| 16 | 230 | 100 | N | 9.6 | 11873 |

The increase of the viscosity (represented by G*) and the decrease of the extraction in xylene (solvent of silicone but not of polyethylene) of silicone is proof of the reaction between the components. Table 1 shows that this reaction is dependent on the extrusion temperature, as well as, in a minor way, the output of the process.

### Example 2: Preparation of the Polyethylene Films with Different Masterbatches

The polyethylene films were made on a small lab extruder having an L/D ratio of 30 and a length of 24 mm. The small extruder was equipped with a blown film die. The films were produced at 200° C., with an output around 1.5 kg/h, and to obtain 20 microns thickness, the pulling speed was set around 5-6 m/min. The same polyethylene (low density, melt flow index (MFI) 8.5) is used as the base material for film production, avoiding compatibility issues between the polyethylene in the film and the polyethylene in the masterbatch. The silicone masterbatch of this present invention or from the conventional masterbatch process described in US U.S. Pat. No. 5,844,031, is added at several rates up to 10% by manually blending the pellets of polyethylene and the pellets of masterbatch and putting the blend directly in the feeder.

### Example 3: Coefficient of Friction (CoF) Data

The coefficient of friction measurements were performed with an Oscillating Tribotester. A 100Cr6 steel ball oft inch (1.27 cm) diameter and a 10 mm eccentric (giving a sliding distance of 20 mm per cycle) are used. A 2N load is applied perpendicularly and the sliding speed is set at 10 mm/s. The ball slides on the film tested with a course of 10 mm back and forth for a total length of 5 m, i.e. 250 cycles. 10 measurements by samples are performed.

TABLE 2
Table 2: Extraction in xylene, coefficient of friction
and complex modulus data for each run carried out
using vinyl endcapped and pendent (0.725% of vinyl
function) high molecular weight silicone polymer.

| | Silicone | | G* at |
|---|---|---|---|
| | extraction in | CoF when 0.5% of initial silicone | 0.1 Hz |
| | xylene (%) | added (in masterbatch form) | (Pa) |
| 1 | 7.1 | 0.073 | 9880 |
| 2 | 25.6 | 0.077 | 6000 |
| 3 | 4.2 | 0.22 | 12140 |
| 4 | 19.2 | 0.08 | 5730 |
| 5 | 11.3 | 0.079 | 9090 |
| 6 | 44.2 | 0.12 | 1920 |
| 7 | 34.8 | 0.07 | 3210 |
| 8 | 44.2 | 0.12 | 1520 |
| 9 | 22.5 | 0.055 | 6150 |
| 10 | 44.8 | 0.116 | 1540 |
| 11 | 13.9 | 0.091 | 11818 |
| 12 | 18.1 | 0.088 | 9512 |
| 13 | 10.1 | 0.084 | 12374 |
| 14 | 11.5 | 0.091 | 11490 |
| 15 | 8.5 | 0.15 | 12709 |
| 16 | 9.6 | 0.09 | 11873 |

From table 2 it can be seen that the coefficient of friction decreases as the viscosity increases and the extraction in xylene decreases proving that the grafting of the gum onto the polyethylene is a key parameter to reduce the coefficient of friction of the final film. But for the highest level of grating (3), the coefficient of friction rises, indicating it is an optimum of grafting to reach to obtain the lowest coefficient of friction.

### Polypropylene (PP) Example

### Example 4: Preparation of the Masterbatch (M) of Different Viscosities and Molecular Weights

Pellets of polypropylene homopolymer (Polyolefin polymer (A)) with a melt flow index of 12 g/10 min (using the testing conditions of temperature of 190° C. and load of 2.16 kg) as the polymer matrix of masterbatch (M) were introduced into a co-rotative twin screw extruder sometimes with stabilizer (typically Irganox® 1010 antioxidant at a rate as indicated in Table 3 below). Then organopolysiloxane (B) was added into the already melted polypropylene phase using a gear pump. The average amount of organopolysiloxane (B) added into matrix polyethylene was about 25 wt. %.

All the components are mixed into a lab twin screw extruder having an L/D ratio greater than 40 (typically 48), diameter of the screw greater than 35 mm (typically 40 mm), then average screw speed is set to 550 rpm with a specific screw profile designed to disperse finely all the components into the polypropylene homopolymer. The mixtures are coiled with a water batch to room temperature and pelletized. The pellets are tested in melt flow index apparatus, at 190° C., under 2.16 kg. The pellets also undergo an extraction test as follows: around 0.24 g of masterbatches were accurately weighted and placed into a 20 ml headspace vial. 10 ml of p-xylene were accurately added (micropipette) and the vial was crimped. The samples were left to solubilize at high temperature (150° C.) for 20 minutes under continuous agitation using the headspace oven and the autosampler of the GC-MS (MPS from Gerstel). After cooling 10 ml of toluene was added and the samples were left under gentle stirring for 24 h (using a rotary shaker). The samples were then filtered through 0.45 μm PTFE filters into 2 ml glass auto sampler vials. All data is depicted in Table 3.

TABLE 3
Table 3: Process conditions, extraction in xylene and melt flow index data for each run carried out using vinyl
endcapped high molecular weight silicone polymer. The 3B sample has been extruded using a high shear apparatus.

| | | | Phenolic | Vinyl content | Silicone | Melt Flow Index |
|---|---|---|---|---|---|---|
| | Screw | | Antioxidant | of the silicone | extraction | (MFI) (conditions |
| Sample | speed (rpm) | Output (kg/h) | at 0.2% (Y/N) | gum (%) | in xylene (%) | 190° C. & 2.16 kg load) |
| 1B | low | high | Y | 0.012 | 22.7 | 5.44 |
| 2B | High | low | N | 0.012 | 23.3 | 9.54 |
| 3B | high | low | N | 0.012 | 18 | 11.34 |

The increase of the MFI values indicates that a chemical reaction occurred during the extrusion process. The higher the MFI value, the greater the degree of grafting between the organopolysiloxane (B) and the polypropylene.

### Example 5: Preparation of the Bi-Oriented Polypropylene Films (BOPP) with Different Masterbatches

Polypropylene films were made on a pilot BOPP line. The process was as followed: stretching in machine direction (MDO) 5, in transverse direction (TDO) 10. The structure of the film was a standard BOPP clear film having 3 layers and being a BOPP clear film 20 um thick, having

(i) A layer of 1 micron terpolymer Adsyl 5C39F;
(ii) 18 microns thick layer of a homopolymer (Sabic 525);
(iii) 1 micron terpolymer Adsyl 5C39F.

An amount of masterbatch (M) was added to one of the Adsyl 5C39F layer (iii). The layer

(i) was Corona treated and the layer (iii) contained antiblock (silica).

### Example 6: Coefficient of Friction Data: ASTM 1894-14 Film Against Film Measurements

In each of the examples, the CoF was measured in accordance with ASTM 1894-14 using a Zwick tensile machine. All data are presented in Table 4.

TABLE 4
Table 4: Silicone content in the external layer, coefficient of friction, melt flow index and haze for
each run carried out using vinyl endcapped high molecular weight silicone polymer and polypropylene.

| | | | | | Surface tension |
|---|---|---|---|---|---|
| | | Dynamic | Melt Flow Index | | (measured by drop |
| | Initial silicone | Coefficient | (MFI) (conditions | Haze measured | angle tests, in |
| | content in the | of Friction | 190° C. & | following ASTM | dynes) (1 Dyne = |
| Sample | external layer (%) | Film/Film (CoF) | 2.16 kg load) | D1003-13 (%) | 1 × 10⁵ N) |
| 1B | 0.5 | 0.300 | 5.44 | 2.77 | 43.1 |
| | 1.25 | 0.410 | | 2.57 | 42.4 |
| | 2 | 0.250 | | 2.37 | 40.9 |
| 2B | 0.125 | 0.510 | 9.54 | 1.28 | 45.5 |
| | 0.5 | 0.460 | | 1.74 | 43.7 |
| | 1.25 | 0.250 | | 2.68 | 41.7 |
| | 2 | 0.170 | | 4.92 | 42.2 |
| 3B | 0.5 | 0.240 | 11.34 | 2.00 | 43.0 |
| | 1.25 | 0.290 | | 2.60 | 44.3 |
| | 2 | 0.210 | | 4.40 | 43.8 |

From the Table 4, we can see that at high level of silicone (1.25 and 2%), the dynamic CoF is reduced for the high MFIs, indicating that the grafting acts in favour of a low CoF in BOPP films. We can also note that there is limited to no effect of our masterbatch on haze in the range tested. The same conclusion can be made with surface tension measurements: if a slight decrease is observed, the surface tension remains higher than 36 dynes, the limit value for printing or metallizing BOPP films.

### Example 7: Coefficient of Friction (COF) Data: Steel Against Film Measurements

Coefficient of friction measurements were performed with the Oscillating Tribotester. A 100Cr6 steel ball oft inch (1.27 cm) diameter and a 10 mm eccentric (giving a sliding distance of 20 mm per cycle) are used. A 2N load is applied perpendicularly and the sliding speed is set at 10 mm/s. The ball slides on the film tested with a course of 10 mm back and forth for a total length of 5 m, i.e. 250 cycles. 10 measurements by samples are performed. The films are compared when containing 2% of masterbatch (M). All data is provided in Table 5.

TABLE 5
Table 5: Masterbatch content in the external layer, coefficient of
friction and melt flow index for each run carried out using vinyl
endcapped high molecular weight silicone polymer and polypropylene.

| | Initial | Dynamic | Melt Flow |
|---|---|---|---|
| | silicone | Coefficient | Index (MFI) |
| | content in the | of Friction | (conditions |
| | external layer | Steel/Film | 190° C. & |
| Sample | (%) | (CoF) | 2.16 kg load) |
| 1B | 0.5 | 0.245 | 5.44 |
| | 1.25 | 0.148 | |
| | 2 | 0.102 | |
| 2B | 0.125 | 0.248 | 9.54 |
| | 0.5 | 0.132 | |
| | 1.25 | 0.066 | |
| | 2 | 0.051 | |
| 3B | 0.5 | 0.094 | 11.34 |
| | 1.25 | 0.075 | |
| | 2 | 0.047 | |

From Table 5 there is a clear correlation between the CoF and the Melt Index values: when compared at 2% loading, when the melt index increases, the CoF decreases, indicating that the grafting of the silicone and the resin decreases the CoF of the final BOPP film. The same conclusion can be made at every loadings.

### Example 8: Stability of the Coefficient of Friction (Steel/Film), Surface Tension Over Time

Surface tension and coefficient of friction was followed over time after the BOPP process. The films were winding and stocked at 23° C. Surface tension evolution data is provided in Table 6.

TABLE 6
Table 6: Masterbatch content in the external layer, surface tension after 6 days, 45 days, 90 days, 135 days and
180 days for each run carried out using vinyl endcapped high molecular weight silicone polymer and polypropylene.

| | Initial silicone | Surface tension | Surface tension | Surface tension | Surface tension | Surface tension |
|---|---|---|---|---|---|---|
| | content in the | (measured by drop | (measured by drop | (measured by drop | (measured by drop | (measured by drop |
| | external layer (%) | angle tests, in dynes) | angle tests, in dynes) | angle tests, in dynes) | angle tests, in dynes) | angle tests, in dynes) |
| | Number of days after extrusion | | | | | |
| Sample | NA | 6 | 45 | 90 | 135 | 180 |
| 1B | 0.5 | 43.1 | 37.2 | 35.1 | 36.5 | 36.5 |
| | 1.25 | 42.4 | 37.5 | 36.4 | 35.9 | 35.3 |
| | 2 | 40.9 | 35.7 | 33.7 | 34.6 | 34 |
| 2B | 0.125 | 45.5 | 40.4 | 40.5 | 38 | 38.5 |
| | 0.5 | 43.7 | 39.5 | 37.5 | 36.4 | 35.1 |
| | 1.25 | 41.7 | 35.9 | 34.3 | 34.5 | 35.5 |
| | 2 | 42.2 | 33.3 | 32.5 | 30 | 29.6 |
| 3B | 0.5 | 43 | 36.2 | 37 | 34.6 | 33.9 |
| | 1.25 | 44.3 | 39.8 | 39.1 | 35.9 | 38.3 |
| | 2 | 43.8 | 34.9 | 33.3 | 31.7 | 33.1 |

(1 Dyne = 1 × 10⁵ N)

As expected, the surface tension drops from around 43 dynes to around 35 dynes after 6 months storage. But no correlation between the silicone amount, or the type of run and this drop have been found. In fact, the drop seems normal and in the same range as our reference (containing 0.125% of silicone). The additive does not seem to have effect on the surface tension of the films.

Coefficient of friction evolution data is provided in table 7.

TABLE 7
Table 7: Masterbatch content in the external layer, coefficient of friction after 30 days, 60 days, 90 days, 135 days
and 180 days for each run carried out using vinyl endcapped high molecular weight silicone polymer and polypropylene.

| | | Dynamic | Dynamic | Dynamic | Dynamic | Dynamic |
|---|---|---|---|---|---|---|
| | Silicone content | Coefficient | Coefficient | Coefficient | Coefficient | Coefficient |
| | in the external | of Friction | of Friction | of Friction | of Friction | of Friction |
| | layer (%) | Steel/Film (CoF) | Steel/Film (CoF) | Steel/Film (CoF) | Steel/Film (CoF) | Steel/Film (CoF) |
| | Number of days after extrusion | | | | | |
| Sample | NA | 30 | 60 | 90 | 135 | 180 |
| 1B | 0.5 | 0.245 | 0.251 | 0.208 | 0.21 | 0.159 |
| | 1.25 | 0.148 | 0.258 | 0.209 | 0.185 | 0.197 |
| | 2 | 0.102 | 0.109 | 0.146 | 0.129 | 0.115 |
| 2B | 0.125 | 0.248 | 0.345 | 0.329 | 0.314 | 0.346 |
| | 0.5 | 0.132 | 0.1 | 0.108 | 0.109 | 0.104 |
| | 1.25 | 0.066 | 0.077 | 0.061 | 0.071 | 0.057 |
| | 2 | 0.051 | 0.057 | 0.046 | 0.038 | 0.038 |
| 3B | 0.5 | 0.094 | 0.154 | 0.097 | 0.089 | 0.064 |
| | 1.25 | 0.075 | 0.078 | 0.074 | 0.068 | 0.067 |
| | 2 | 0.047 | 0.059 | 0.042 | 0.059 | 0.041 |

The coefficient of friction remains stable after 6 months storage, for each run. The little variation can be attributed to standard deviation of the measurement, which is around 8 to 10%. The additive presents then long term efficiency in slip properties.

1. A plastic packaging film comprising a core layer and two opposite outer layers, wherein an outer layer is obtainable by:
(i) forming a masterbatch (M) by reactively mixing under shear an organopolysiloxane (B) containing on average at least 1 alkenyl functionality per molecule with a polyolefin polymer (A), at a temperature such that the organopolysiloxane (B) and the polyolefin polymer (A) are in liquid phase, so as to form a copolymer of (A) and (B) then cooling the formed copolymer to produce said masterbatch (M) in solid form containing organopolysiloxane (B), polyolefin polymer (A) and the copolymer of (A) and (B); then
(ii) introducing, per 100 parts by weight, 0.01 to 10 parts by weight of masterbatch (M) into 99.99 to 90 parts by weight of a polyolefin polymer (P) and blending to form a composition, and
(iii) making a film by processing the composition of step (ii).

2. The plastic film according to claim 1 wherein the polyolefin polymer (A) and/or the polyolefin polymer (P) is a blend of polyolefins.

3. The plastic film according to claim 1, wherein the polyolefin polymer (A) and/or the polyolefin polymer (P) are functionalized, preferably with an alkyl acrylate function such as methyl acrylate, ethyl acrylate, butyl acrylate, or an acrylic function or maleic anhydride function.

4. The plastic film according to claim 1 wherein the polyolefin polymer (P) comprises polypropylene and/or polyethylene.

5. The plastic film according to claim 1 wherein the polyolefin polymer (A) comprises polypropylene and/or polyethylene.

6. The plastic film according to claim 1 wherein the organopolysiloxane (B) has a number average molecular weight of 200,000 to 2.000,000 g/mole.

7. The plastic film according to claim 1 wherein the alkenyl functionalities of the organopolysiloxane (B) comprise vinyl functionalities and wherein the vinyl functionalities are present in an amount comprised between 0.01% and 2.00% by weight of the organopolysiloxane (B).

8. A method of making a plastic packaging film comprising a core layer and two opposite outer layers, wherein an outer layer is made by:
(i) forming a masterbatch (M) by reactively mixing under shear an organopolysiloxane (B) containing on average at least 1 alkenyl functionality per molecule with a polyolefin polymer (A), at a temperature such that the organopolysiloxane (B) and the polyolefin polymer (A) are in liquid phase, so as to form a copolymer of (A) and (B) then cooling the formed copolymer to produce said masterbatch (M) in solid form containing organopolysiloxane (B), polyolefin polymer (A) and the copolymer of (A) and (B); then
(ii) introducing, per 100 parts by weight, 0.01 to 10 parts by weight of masterbatch (M) into 99.99 to 90 parts by weight of a polyolefin polymer (P) and blending to form a composition and
(iii) making a film by processing the composition of step (ii).

9. The method according to claim 8, wherein the polyolefin polymer (A) and/or the polyolefin polymer (P) are functionalized, preferably with an alkyl acrylate function such as methyl acrylate, ethyl acrylate, butyl acrylate, or an acrylic function or maleic anhydride function.

10. The method according to claim 8 wherein the polyolefin polymer (P) comprises polypropylene and/or polyethylene.

11. The method according to claim 8 wherein the polyolefin polymer (A) comprises polypropylene and/or polyethylene.

12. The method according to claim 8 wherein the organopolysiloxane (B) is linear.

13. The method in accordance with claim 8 wherein step (iii) is selected from one or more of extrusion, co-extrusion, lamination, melt pressing, and coating methods or a combination thereof.

14. The method in accordance with claim 8 wherein step (iii) involves one or more of cast co-extrusion or blown co-extrusion methods, adhesive lamination, extrusion lamination, thermal lamination, melt pressing and coating methods such as vapour deposition.

15. A plastic film in accordance with claim 1 wherein the polymer composition additionally comprises one or more additives selected from antistatic additives, anti-blocking additives and/or anti-fogging additives.

16. A plastic film in accordance with claim 1 wherein step (iii) is selected from one or more of extrusion, co-extrusion, lamination, melt pressing, and coating methods or a combination thereof.

17. A plastic film in accordance with claim 1 wherein step (iii) involves one or more of cast co-extrusion or blown co-extrusion methods, adhesive lamination, extrusion lamination, thermal lamination, melt pressing and coating methods such as vapour deposition.

18. The method according to claim 8 wherein the polyolefin polymer (A) and/or the polyolefin polymer (P) is a blend of polyolefins.
